(19) United States
(12) Patent Application Publication
(10) Pub. No.: US 2011/0302312 A1
(43) Pub. Date: Dec. 8, 2011

(54) CLOUD RESOURCE PROXY WITH ATTRIBUTE MIRRORING

(76) Inventor: Dave Dennis McCrory, Pflugerville, TX (US)

(21) Appl. No.: 13/152,257

(22) Filed: Jun. 2, 2011

Related U.S. Application Data
(60) Provisional application No. 61/350,579, filed on Jun. 2, 2010.

(51) Int. Cl. G06F 15/173

(52) U.S. Cl. 709/226

(57) ABSTRACT

In one or more embodiments, one or more methods and/or system described can provide one or more solutions for controlling and managing cloud-based computing resources by providing a bridge between traditional management approaches in an enterprise and cloud-based approaches. These approaches are moving into the enterprise environment and will require re-architecting of systems and software and training of personnel to be successful. By abstracting away the cloud resources and making the cloud resources appear as local resources, the complexity of management and control can be greatly reduced. In one or more embodiments, local enterprise system can interface with a reverse proxy that can provide a single or uniform application programming interface to one or multiple cloud-based computing resources. This approach, using the reverse proxy that can provide a single or uniform application programming interface, can reduce the complexity of management and control of the cloud-based computing resource(s).

This application claims benefit of U.S. Provisional Application Ser. No. 61/350,579, filed Jun. 2, 2010, titled “Cloud Resource Proxy with Attribute Mirroring”, which application is hereby incorporated by reference in its entirety as though fully and completely set forth herein.

### BACKGROUND

1. Technical Field

This disclosure relates generally to distributed computing, and more particularly to a method and system for controlling one or more distributed computing systems.

2. Description of the Related Art

There is a growing movement in using technologies around Cloud Computing. Cloud Computing is a term that covers a broad spectrum of solutions, service delivery models, and capabilities offered. Presently there are three different classifications for Cloud Computing (although this may grow to a far larger number as the industry and the Internet progress). Partial deployments and/or Hybrid Deployments are possible with Hybrid appearing to be a trend into the future. These three classifications of Cloud Computing include: Infrastructure as a Service (IaaS), Platform as a Service (PaaS), and Software as a Service (SaaS).

IaaS refers to a compute resource being made available in a service fashion. Common examples of IaaS available today include Amazon S3 (which is a basic storage solution accessible securely over the internet), Amazon EC2 (which is a Virtual Machine accessible both securely and/or insecurely over the internet), Rackspace/Slicehost VPS (which is a Virtual Machine Partition accessible via. the internet), Terremark vCloud Express (A VMware based Virtual Machine or Virtual Machine Environment Comprised of several Virtual Machines available through the internet). IaaS allows Administrators and/or Developers to connect core IT Infrastructure components such as Storage, Network, and Computer resources together to create a custom platform or solution.

PaaS refers to a predefined platform that allows Administrators, Users, and Developers to run Applications on resources in a Cloud. Examples of PaaS include Microsoft Azure SQL (This is a solution hosted by Microsoft that allows a developer to use a Microsoft based SQL Server over the internet for their solution instead of having to install, setup, license, manage, and maintain a SQL Server locally), Google AppEngine (Allows developers to run Python and Java JVM based solutions on Google's Platform as if they were running it on their own machine), Amazon RDBMS is Amazon's equivalent service to Microsoft SQL Azure.

SaaS is a model where the entire solution including the software processing and administration is done through a providers interface. The solution is a complete product that is used by end users over the Internet and both administrators and developers manage and develop against the software and backend all over the internet. Two of the biggest examples of this are Salesforce.com and Netsuite.com.

Hybrid Deployments (also referred to commonly as Hybrid Clouds) are where mixes of IaaS, PaaS, and SaaS are used. These mixes may be local based for example thcould be a program written locally that happens to point to Salesforce (a SaaS) for some specific data, but yet the program and its users are behind a firewall in the Enterprise. Another mix may be leveraging a mix of SaaS, PaaS, and/or IaaS to create a custom solution, an example of this being the recent announcements regarding VMware partnering with Salesforce.com to create VMforce and VMware partnering with Google to run SpringSource solutions on Google AppEngine.

In the past, these solutions remove efficiencies and control points that administrators (IT, Systems, Application, Network, etc.) traditionally have had, while making developers more likely to depend on services and resources that are not necessarily permanent. Resources that are created in a Cloud (whether they be IaaS, SaaS, or PaaS) require less maintenance because the equipment and other components can be located (and in many cases owned) by another entity. One issue with this is that it changes to tools, skill sets, and requirements of an enterprise (or even a medium to small business) because of the new resource abstractions that are being imposed. The cost models are also very different when using Cloud-based resources, this is due to most Cloud expenses being use or utilization based. With services such as Amazon EC2 customers are charge based on administrative functions such as reboots, hourly CPU consumption, up and downstream bandwidth, and potentially add-on services such as Amazon Cloudwatch that allows Administrators to monitor uptime and utilization through an alternative Amazon service (at an additional hourly cost).

Each of these Cloud solutions also has its own API (application programming interface) which requires a custom implementation to use. Thus, an administrator or developer requires special training, understanding new architectures, and education regarding new procedures, new tools, new policies, new security, new rules, new compliance, and new programming languages (and/or libraries) to utilize a Hybrid-based Cloud approach.

### BRIEF DESCRIPTION OF THE DRAWINGS

The embodiments will become apparent upon reading the following detailed description and upon reference to the accompanying drawings in which:

FIG. 1 illustrates an exemplary computer network system, according to one or more embodiments;

FIG. 2 illustrates an exemplary computer network system that provides further details, according to one or more embodiments;

FIG. 3 provides another exemplary computer network system that provides further details, according to one or more embodiments;

FIG. 4 illustrates a diagram of an exemplary control manager, according to one or more embodiment;

FIG. 5 illustrates a diagram of an exemplary interface computing device and an exemplary interface process, according to one or more embodiments;

FIG. 6 provides another diagram of an exemplary interface computing device and exemplary interface processes, according to one or more embodiments;

FIG. 7 illustrates a diagram of an exemplary interface computing device, exemplary interface processes, and a split cloud resource configuration, according to one or more embodiments;

FIG. 8 provides a block diagram of a computing device, according to one or more embodiments;

FIG. 9 illustrates a method that provides one or more cloud resources to a computing device, according to one or more embodiments; and

FIG. 10 illustrates a method that provides a resource to a computing device, according to one or more embodiments.

### DETAILED DESCRIPTION

In one or more embodiments, a system and method can be utilized to abstract Cloud-based resources via one or more proxy-based transformations and/or augmentation services. By abstracting Cloud-based resources (including things such as services under PaaS, IaaS, and/or SaaS) a system can present an appearance and/or capabilities of Cloud-based resources as being local to an enterprise (e.g., a business, a local computer system, etc.). This ability can eliminate one or more requirements to use or implement new management tools, rules, requirements, use of different programming languages, security, etc. Additionally, this approach can allow developers new insight into what is occurring inside an application and its communications with other components (many of which can actually be Cloud-based resources).

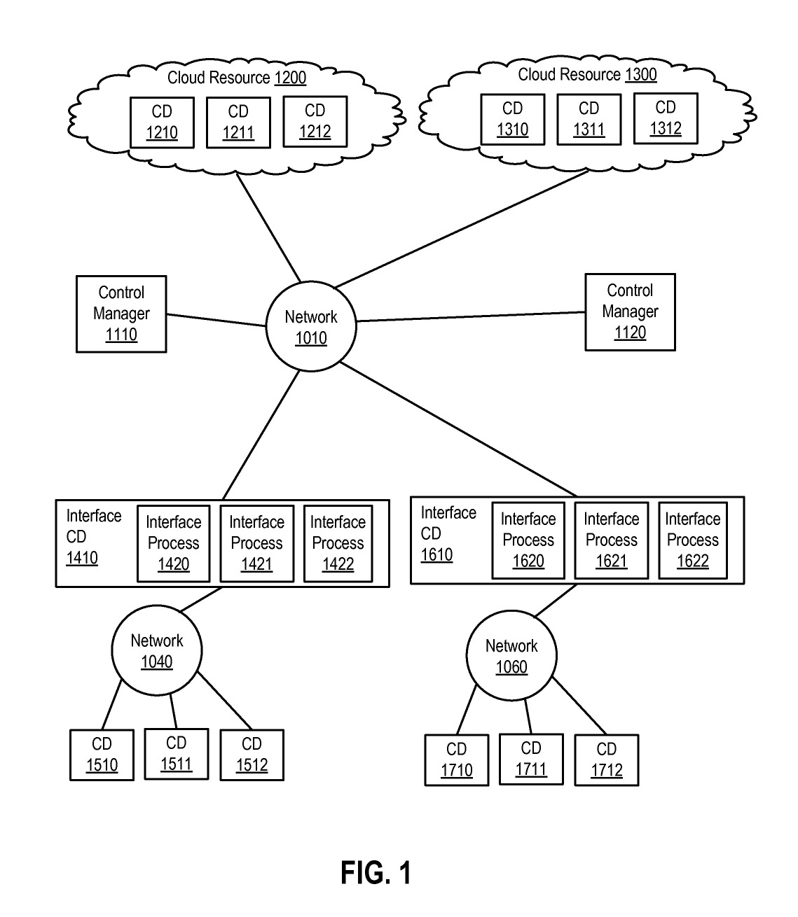

Turning now to FIG. 1, an exemplary computer network system is illustrated, according to one or more embodiments. As illustrated, cloud resources 1200 and 1300 can be coupled to a network 1010. In one or more embodiments, network 1010 can be or can include a public network. For example, the public network can be or can include an Internet. As shown, cloud resources 1200 and 1300 can include computing devices (CDs) 1210-1212 and 1310-1312, respectively. In one or more embodiments, a cloud resource (e.g., cloud resource 1200, cloud resource 1300, etc.) can include many computing devices that can be distributed throughout a geographic and/or special region.

As illustrated, control managers 1110 and 1120 and interface CDs 1410 and 1610 can be coupled to network 1010. As shown, interface computing device (CD) 1410 and CDs 1510-1512 can be coupled to a network 1040, and interface CD 1610 and CDs 1710-1712 can be coupled to a network 1060. In one or more embodiments, each of networks 1040 and 1060 can be or can include a private and/or a local network. For example, each of networks 1040 and 1060 can be or can include a private and/or a corporate network.

As illustrated, each of interface CDs 1410 and 1610 can include interface processes 1420-1422 and 1620-1622, respectively. In one or more embodiments, an interface process can provide a single or uniform application programming interface (API) to one or ore cloud resources. For example, interface process 1420 can provide a first API to one or more of CDs 1510-1512 and can interface with a second API of cloud resource 1200 and/or with a third API of cloud resource 1300. For instance, the second API and the third API can differ. In one or more embodiments, an interface process (e.g., interface process 1420) can translate and/or transform a first API into a second API and/or a third API. Interface processes 1421, 1422, and 1620-1622 can include same or similar structures and/or functionalities described with reference to interface process 1420.

In one or more embodiments, a control manager (e.g., control manager 1110, control manager 1120, etc.) can provide an interface process (e.g., interface process 1420) with information regarding resources utilized. For example, CD 1510 can utilize interface process 1420 to interface with one or more of cloud resources 1200 and 1300, and control manager 1110 can provide interface process 1420 with information associated with computing resources (e.g., bandwidth, disk space, CPU utilization, etc.) of the one or more of cloud resources 1200 and 1300 utilized by CD 1510. In one or more embodiments, the information associated with computing resources (e.g., bandwidth, disk space, CPU utilization, etc.) of the one or more of cloud resources 1200 and 1300 utilized by CD 1510 can be utilized by an administrator and/or a developer. For example, one or more of CD 1511 and 1512 can also utilize interface process 1420 to interface with one or more of cloud resources 1200 and 1300, and the information associated with computing resources of the one or more of cloud resources 1200 and 1300 utilized by one or more of CD 1511 and 1512 can be utilized by an administrator and/or a developer.

In one or more embodiments, an interface process can be or include a process, a thread, or a virtual machine, among others. In one example, interface process 1420 can appear to be a single computing resource to one or more of CDs 1510-1512. In one instance, control manager 1110 can provide and/or update one or more states associated with one cloud resource or an aggregate of cloud resources. In another instance, control manager 1110 can provide and/or update one or more states associated with CD 1210 of cloud resource 1210. For example, interface process 1420 can appear to be CD 1210 of cloud resource 1210. For instance, interface process 1420 can be a virtual machine, and control manager 1110 can provide and/or update meta data associated with CD 1210 of cloud resource 1210 that can allow interface process 1420 to appear to be CD 1210 of cloud resource 1210.

In one or more embodiments, one or more of networks 1010, 1040, and 1060 can include a wired network, a wireless network or a combination of wired and wireless networks. One or more of networks 1010, 1040, and 1060 can include and/or be coupled to various types of communications networks, such as a public switched telephone network (PSTN), an Internet, a wide area network (WAN) (e.g., a private WAN, a corporate WAN, a public WAN, etc.), a local area network (LAN). In one or more embodiments, one or more of networks 1010, 1040, and 1060 can include one or more wireless networks, e.g., based on IEEE 802.11 and/or IEEE 802.16. One or more of networks 1010, 1040, and 1060 can include one or more DSL (digital subscriber line) and/or cable (e.g., cable television) networks and/or infrastructures. For example, one or more of networks 1010, 1040, and 1060 can include one or more of: cable modems, cable modem termination systems (CMTSs), satellite modems, DSL modems, digital subscriber line access multiplexers (DSLAMs), broadband remote access servers (BRASs), telecommunications circuits, and/or metropolitan area networks (MANs), among others. In one or more embodiments, network 1010 may form part of the Internet, or may couple to other networks, e.g., other local or wide area networks such as the Internet.

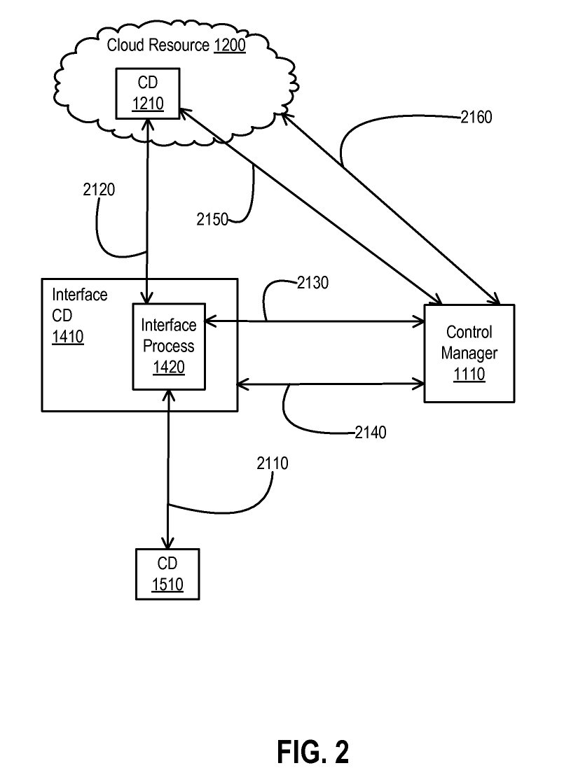

Turning now to FIG. 2, an exemplary computer network system that provides further details is illustrated, according to one or more embodiments. As illustrated, CD 1510 can communicate with interface process 1420 via a communications path 2110, and interface process 1420 can communicate with CD 1210 via a communications path 2120. In one or more embodiments, interface process 1420 can unconditionally accept data from CD 1510, or interface process 1420 can selectively accept data from CD 1510 and can determine what should be done with the data. In one example, the determination can be as simple as forwarding the data to CD 1210. In a second example, the determination can be as complex as altering the content of the data and routing the data to control manager 1110 via a communications path 2130. In a third example, interface process 1420 can query control manager 1110, via communications path 2130, where the data should be routed. In another example, interface process 1420 can query control manager 1110, via communications path 2130, how the data should be processed. In one or more embodiments, interface process 1420 can utilize multiple rules to selectively accept data from CD 1510 and/or to determine what should be done with the data.

In one or more embodiments, control manager 1110 can instruct interface CD 1410, via a communications path 2140, with information that can allow interface CD 1410 to present interface process 1420 with an appearance of additional attributes not normally related to a router or proxy or traffic processing device. For example, the information can be artificial, derived, or directly mirrored from one or more cloud resources (e.g., cloud resource 1200, cloud resource 1300, etc.). In one instance, control manager 1110 can provide and/or update one or more states associated with CD 1210 that can be emulated, indicated, and/or exhibited by interface process 1420. In another instance, control manager 1110 can derive one or more states associated with an aggregate of two or more computing device of a single cloud resource or an aggregate of two or more cloud resources. In one or more embodiments, control manager can utilize multiple rules in providing the information that can be artificial, derived, or directly mirrored from one or more cloud resources.

As illustrated in exemplary FIG. 2, a one-to-one direct selective mirror of attributes is provided, according to one or more embodiments. For example, direct selective attribute mirroring can include mirroring a subset of available and/or mirror-able attributes. For instance, the attributes can include one or more of a power state of a cloud resource, an instance state, an identity, one or more performance metrics, one or more utilization metrics, utilization data, configuration information, uptime, an operating system, guest information associated with a virtual machine, one or more available application programming interfaces (APIs), virtual machine information (e.g., types, capabilities, libraries, utilization, performance, profile, configuration, etc.), and a framework (e.g., SpringSource IoC and associated libraries, Butterfly IoC, Cairngorm for Adobe Flex, Zend, etc.), among others.

In the example illustrated in FIG. 2, the selective attribute mirror can include providing power state and utilization metrics that can provide an appearance to local tools, applications, APIs, etc. that interface process 1420 is a resource that has characteristics of a resource that exists in cloud resource 1200. In one example, if CD 1210 is powered off or terminated (e.g., CD 1210 can be a virtual machine that can be started and/or terminated), interface process 1420 would appear as a computing device or resource that is powered off and/or is in a shutdown state. In a second example, if CD 1210 is running or processing at eighty percent (80%) utilization, interface process 1420 can appear to be running at eighty percent (80%) utilization via selective attribute mirroring.

In one or more embodiments, the selective attribute mirror can be bidirectional. For example, if the selective attribute mirroring is set as bi-directional, then attribute changes that are performed on interface process 1420 can affect CD 1210. In one or more embodiments, control manager 1110 can coordinate one or more changes to one or more selective attributes. In one example, control manager 1110 can coordinate one or more changes utilizing interfaces and logic performing via communications path 2130 for direct inquiry and manipulation of interface process 1420. In a second example, control manager 1110 can coordinate one or more changes utilizing interfaces and logic performing via communications path 2140 for external insight, inquiry, and indirect manipulation of interface process 1420 via interface CD 1410. In a third example, control manager 1110 can coordinate one or more changes utilizing interfaces and logic performing via a communications path 2150 for direct inquiry and manipulation of CD 1210. In another example, control manager 1110 can coordinate one or more changes utilizing interfaces and logic performing via a communications path 2160 for external insight, inquiry, and indirect manipulation of CD 1210 via cloud resource 1200.

In one or more embodiments, each of one or more of communications paths 2110-2160 can include a communications path of a network. In one example, the communications path of the network can include utilizing an Internet protocol (IP). In a second example, the communications path of the network can include utilizing a transmission control protocol (TCP). In a third example, the communications path of the network can include utilizing a user datagram protocol (UDP). In a fourth example, the communications path of the network can include utilizing a simple network management protocol (SNMP). In another example, the communications path of the network can include utilizing a combination of protocols. For instance, a combination of protocols can include TCP and IP (TCP/IP), UDP and IP (UDP/IP), etc. In one or more embodiments, each of one or more of communications paths 2110-2160 can utilized one or more systems, processes, and/or methods to encrypt data. For example, a communications path (e.g., a communications path of communications paths 2110-2160) can be or can include a communications path that utilizes transport layer security (TLS), HTTPS (secure hypertext transfer protocol), a secure tunnel, and/or a secure socket layer (SSL), among others.

In one or more embodiments, the components illustrated in FIG. 2 can be combined into one or more computing devices and/or one or more virtual machines. In one example, interface CD 1410 (along with interface process 1420) can be included in cloud resource 1200, while control manager 1110 and CD 1510 can remain external to cloud resource 1200. In a second example, control manager 1110 can be provided by a SaaS, PaaS, or IaaS provider that is external to cloud resource 1200. In another example, interface CD, interface process 1420, and control manager 1110 can be included in cloud resource 1200. For instance, one or more services provided by interface CD, interface process 1420, and control manager 1110 can bundled into one or more service provided by cloud resource 1200.

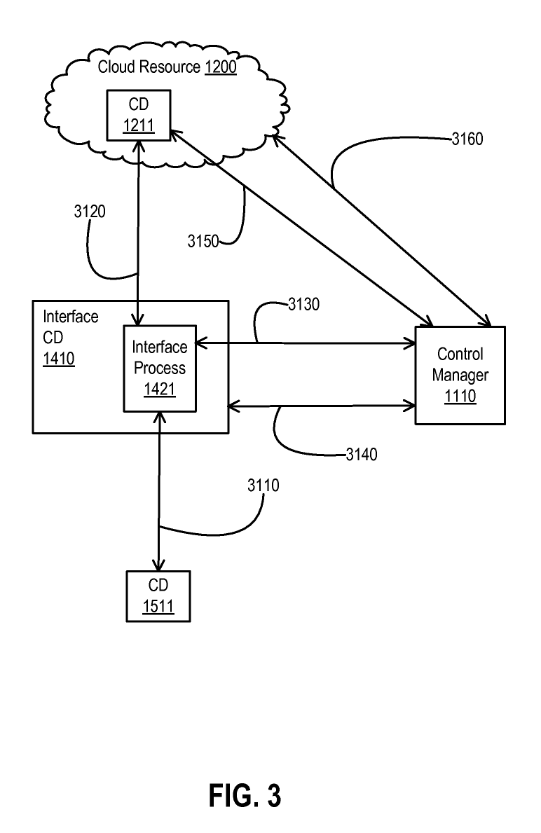

Turning now to FIG. 3, another exemplary computer network system that provides further details is illustrated, according to one or more embodiments. In one or more embodiments, control manager 1110 can provision additional resources from cloud resource 1200. For example, control manager 1110 can provision CD 1211 of cloud resource 1200 and interface process 1421. In one instance, control manager 1110 can provision CD 1211 of cloud resource 1200 based on a request (e.g., a request from one or more of CDs 1510-1512) and, after CD 1211 is provisioned, can provision interface process 1421. In another instance, control manager 1110 can provision interface process 1421 based on a request (e.g., a request from one or more of CDs 1510-1512) and, after interface process 1421 is provisioned, can provision CD 1211. In one or more embodiments, this can be different from “cloud bursting” (e.g., providing additional computation resources on an as needed basis) and such techniques as resources may not be built based on increased demands but can be built to maintain continuity with another portion of a mirror. In one or more embodiments, CD 1211, CD 1511, interface process 1421 and communications paths 3110-3160 can include same or similar structures and/or functionalities as those described with reference to CD 1210, CD 1510, interface process 1420 and communications paths 2110-2160 of FIG. 2.

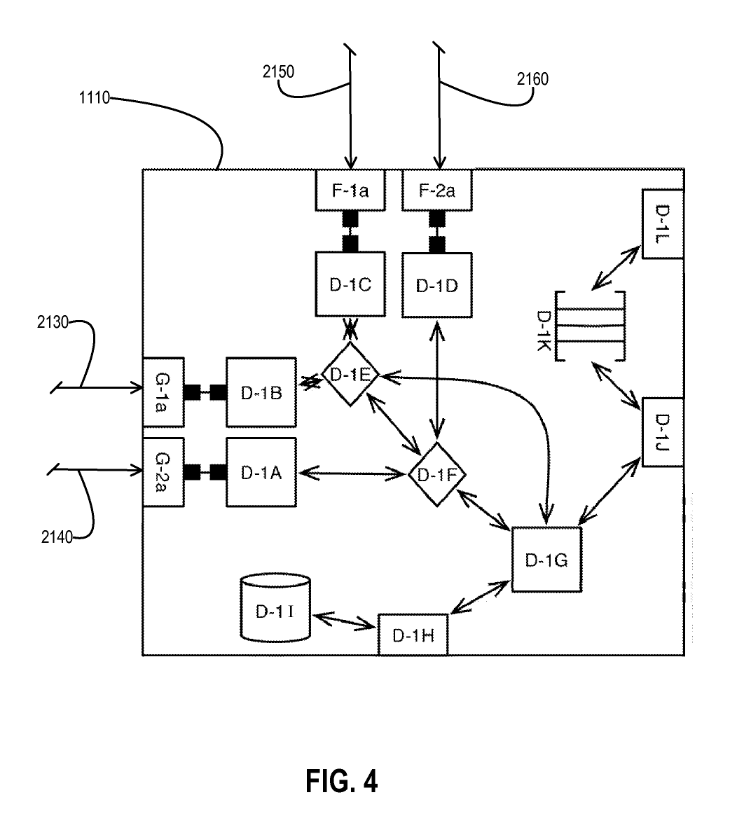

Turning now to FIG. 4, a diagram of an exemplary control manager is illustrated, according to one or more embodiments. As illustrated, control manager 1110 can include logical/programmatic connectivity G-1a that can provide connectivity to interface process 1420. For example, programmatic connectivity G-1a can be utilized when control manager 1110 is included in interface CD 1410 or is external to interface CD 1410. Control manager 1110 can include logical/programmatic connectivity G-2a that can provide connectivity to interface CD 1410. For example, programmatic connectivity G-2a can be utilized when control manager 1110 is included in interface CD 1410 or is external to interface CD 1410.

As shown, control manager 1110 can include logical/programmatic connectivity F-1a that can provide connectivity to CD 1210. In one or more embodiments, a location of control manager 1110, in relation to cloud resource 1200 and/or CD 1210, can determine what type of connectivity is used/maintained via logical/programmatic connectivity F-1a. Control manager 1110 can include logical/programmatic connectivity F-2a that can provide connectivity to cloud resource 1200. In one or more embodiments, a location of control manager 1110, in relation to cloud resource 1200 and/or CD 1210, can determine what type of connectivity is used/maintained via logical/programmatic connectivity F-2a.

As illustrated, control manager 1110 can include initial evaluation of information D-1A that is associated with an initial evaluation of information regarding interface CD 1410. For example, initial evaluation of information D-1A can include monitoring the status of interface process 1420 externally, controlling service that represents interface process 1420, an interface that represents interface process 1420, a Java virtual machine (JVM) or a virtual machine that represents interface process 1420, a manipulation of determined and/or computed statistics that make up interface process 1420, and/or monitoring status of interface process 1420, among others. Control manager 1110 can include initial evaluation of information D-1B that is associated with an initial evaluation of information regarding interface process 1420. In one example, initial evaluation of information D-1B can differ from initial evaluation of information D-1A in that this information is controlled and sent directly to and from interface process 1420. In another example this information can include packets requiring external manipulation or require external logic applied that interface CD 1410 and/or interface process 1420 may be incapable of performing.

As shown, control manager 1110 can include initial evaluation of information D-1C that is associated with an initial evaluation of information regarding CD 1210. For example, initial evaluation of information D-1C can be determined from one or more resources provided by CD 1210 and can allow control, modification, and/or manipulation of the one or more resources provided by CD 1210. For instance, control, modification, and/or manipulation of the one or more resources provided by CD 1210 can include one or more of provisioning and de-provisioning of services and capabilities, health-checks, performance monitoring, utilization monitoring, state monitoring, configuration changes, firewall modifications, and service starts-stops-restarts, among others. In one or more embodiments, control, modification, and/or manipulation of the one or more resources provided by CD 1210 can utilize communications path 2150.

As illustrated, control manager 1110 can include initial evaluation of information D-1D that is associated with an initial evaluation of information regarding CD 1210 indirectly via cloud resource 1200 and communications path 2160. For example, initial evaluation of information D-1D can be determined from one or more resources provided by CD 1210 and can allow control, modification, and/or manipulation of the one or more resources provided by CD 1210. For instance, control, modification, and/or manipulation of the one or more resources provided by CD 1210 can include one or more of provisioning and de-provisioning of the C-2 instance, external health-checks, external performance, external utilization, external configuration changes, and service/firewall modifications based on cloud resource 1200, among others. In one or more embodiments, D-1D can be utilized as an external control point to CD 1210 as compatibility with authentication and other control mechanisms that cloud resource 1200 may utilize for one or more of a virtual machine, a web service, software, and another cloud resource, among others.

As shown, control manager 1110 can include a decision switch or determination mechanism D-1E that can determine if data is being processed whether or not the data needs to be directly routed to an intended destination or whether or not a manipulation that is external is required to take place (outside of interface CD 1410 or interface process 1420). If so, determination mechanism D-1E can send the data to D-1G that can provide access to interface of D-1H. D-1H can interface with D-1I that can include a data store that can be included in control manager 1110 or can be external to control manager 1110. If D-1I is external to control manager 1110, D-1H would provide an interface to communicate with D-1I or D-1J and would provide an interface to a queue D-1K that can process and send or request and respond to D-1I. D-1E can also communicate with a decision switch or determination mechanism D-1F in the event that additional information is required to be requested or supplied.

As illustrated, control manager 1110 can include decision switch or determination mechanism D-1F that can determine if external views of mirrored resources require any additional information to maintain a mirror. In one or more embodiments, determination mechanism D-1F can be utilized in maintaining an appearance that interface process 1420 is providing services that can successfully be backed by CD 1210. If an instance is destroyed or changes of interface process 1420 or CD 1210, D-1F can include logic to request what is required to maintain the mirror and execute and/or perform those requirements.

As shown, control manager 1110 can include a coordination hub D-1G that can be coupled to decision mechanism D-1E, decision mechanism D-1F, interface D-1H, and interface D-1J. For example, coordination hub D-1G can coordinate and/or provide communications from one of decision mechanism D-1E, decision mechanism D-1F, interface D-1H, and interface D-1J to another of decision mechanism D-1E, decision mechanism D-1F, interface D-1H, and interface D-1J. In one or more embodiments, coordination hub D-1G can work in coordination with interface D-1J and interface D-1H to determine what operations may be required to be performed, how to perform those operations, and when to perform those operations. For example, this can allow for complex coordination of mirrors and/or containers (such as if many interface CDs were to be coordinated).

As shown, control manager 1110 can include data store interface D-1H that can provide an ability to persist data. For example, the data can be persisted locally and/or externally. For example, data store interface D-1H can provide access to multiple data stores and/or a document store based data store for special purposes such as a specific type of manipulation and/or modification that is required to occur. In one or more embodiments, a data store can include key-value data and/or a relational database management system. In one or more embodiments, the persisted data can include one or more of configuration data, performance metrics, rules, security parameters, and compliance information, among others.

As illustrated, control manager 1110 can include data store D-1I. In one example, data store D-1I can be included in one or more memory devices that can include volatile memory and/or non-volatile memory. In a second example, data store D-1I can be included in one or more of a relational database management system, a key-value based database, an object-based data store, an object relational mapping, and a document store, among others. In another example, data store D-1I can be included in a combination of two or more of a relational database management system, a key-value based database, an object-based data store, an object relational mapping, and a document store, among others.

As shown, control manager 1110 can include queue interface D-1J that can include a job queue interface and can allow one or more systems, processes, and/or methods described herein to provide and subscribe to functions in an order of those provided by a message queuing protocol. In one example, the message queuing protocol can include an advanced message queuing protocol. In another example, the message queuing protocol can include an active message queuing protocol. In one or more embodiments, queue interface D-1J can provide access to multiple queues. In one example, a first queue can be utilized for clustering or high-availability purposes. In a second example, a second queue can be utilized for job processing. In another example, a third queue can be utilized for manipulation and/or modification of one or more systems described herein. In one instance, queue interface D-1J can utilize and/or implement even queuing. In another instance, queue interface D-1J can utilize and/or implement event queuing. For example, queue interface D-1J can utilize and/or implement one or more queuing technologies, processes, methods and/or techniques depending on one or more requirements of one or more systems, processes, and/or methods described herein.

As shown, control manager 1110 can include queue D-1K. In one example, queue D-1K can be or can include an active message queuing protocol-based server (e.g., ActiveMQ, RabbitMQ, etc.). In another example, queue D-1K can be or can include any type of queuing solution. As illustrated, control manager 1110 can include an external queue interface D-1L that can allow for coordination via a separate queue interface. In one or more embodiments, external queue interface D-1L can be necessary for one or more configurations.

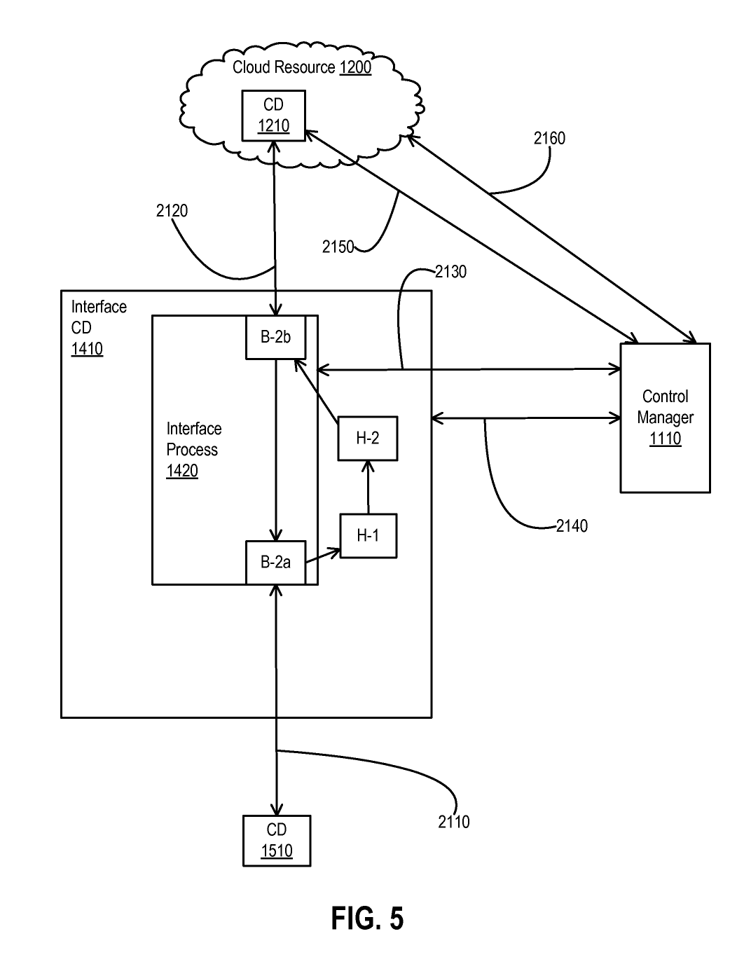

Turning now to FIG. 5, a diagram of an exemplary interface computing device and an exemplary interface process is illustrated, according to one or more embodiments. As illustrated, interface process 1420 can include a network connection B-2a that can be associated with an IP address and that can route requests and/or responses from and/or to CD 1510 via communications path 2110. In one or more embodiments, B-2a can include a logical interface. In one example, network connection B-2a can be physically different from a network connection B-2b. In a second example, network connections B-2a and B-2b can be logically different and share a same physical network interface.

As shown, interface process 1420 can include network connection B-2b that can be associated with an IP address and that can receive and/or send requests and/or responses from and/or to CD 1210 via communications path 2120. In one or more embodiments, the IP address associated with network connection B-2b can be different from the IP address associated with network connection B-2a. As illustrated, interface CD 1410 can include modules H-1 and H-2 that can provide one or more functions that can include one or more of detection, manipulation, alteration, automation, and identification, among others.

In one or more embodiments, interface process 1420 can include multiple processes that can work in conjunction with each other. For example, modules H-1 and H-2 can respective processes that can work and/or be performed in conjunction with each other. In one or more embodiments, interface process 1420 can monitor a process-specific and/or application-specific software construct that can serve as a communications endpoint. For example, the process-specific and/or application-specific software construct that can serve as the communications endpoint can include an Internet port number. For instance, interface process 1420 can monitor and/or listen to port eighty (80) which is a common port number for a hypertext transfer protocol (HTTP).

For example, network connection B-2a can receive a request from CD 1510 via communications path 2110. In one example, the request can include a HTTP request. For instance, network connection B-2a can monitor and/or listen to port eighty (80) which CD 1510 can use as an endpoint, where interface process 1420 is backed by one or more capabilities and/or services provided by CD 1210 which can be accomplished in a few steps. Network connection B-2a can receive a request via port eighty (80) and send the request to module H-1 for evaluation. Module H-1 can determine that a modification is required so that CD 1210 can successfully process and/or reply to the request and can direct the request to module H-2 for modification.

For example, the modification can include a translation and/or transformation from a first API to a second, different, API. Module H-2 can perform the modification and can send the request to network connection B-2b. B-2b can send the request to CD 1210 via communications path 2120. In one or more embodiments, the request can be or can include a modified request (e.g., modified from a first API to a second, different, API). CD 1210 can respond to the request by sending a response to network connection B-2b via communications path 2120. Network connection B-2b can send the response to network connection B-2a, and network connection B-2a can send the response to CD 1510 via communication path 2110. For example, network connection B-2a can send the response to CD 1510 as if network connection B-2a were an originator of the response. In this fashion, interface process 1420 can function as a reverse proxy of CD 1210. In one or more embodiments, while communications and/or processing among CD 1510, interface CD 1410, interface process 1420, and CD 1210 occur, control manager 1110 can monitor interface CD 1410, interface process 1420, and CD 1210 so that health, utilization, and other characteristics re properly mirrored such that the appearance of interface process 1420 can be maintained correctly for selected attributes.

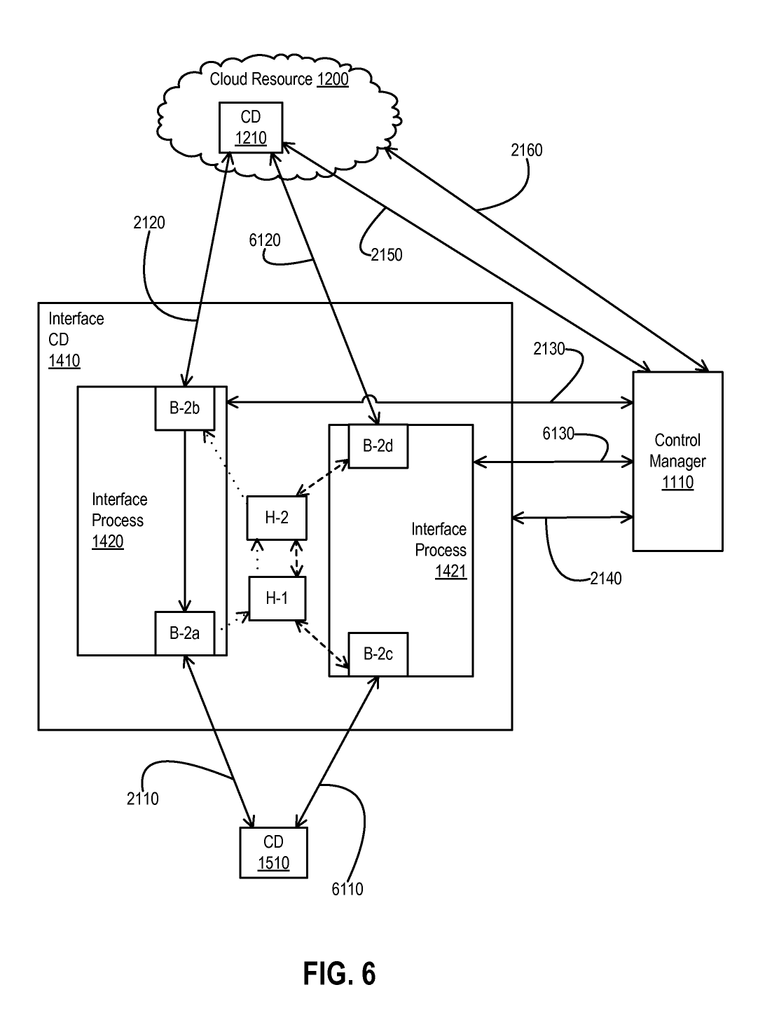

Turning now to FIG. 6, another diagram of an exemplary interface computing device and exemplary interface processes is illustrated, according to one or more embodiments. As illustrated, CD 1510 can be coupled to interface process 1421 via a communications path 6110. In one or more embodiments, communications path 6110 can include same or similar one or more structures and/or functionalities as described with reference to communications path 2110. In one or more embodiments, interface process 1421 can monitor a process-specific and/or application-specific software construct that can serve as a communications endpoint. For example, the process-specific and/or application-specific software construct that can serve as the communications endpoint can include an Internet port number. For instance, interface process 1421 can monitor and/or listen to port twenty-two (22) which is a common port number for secure shell (SSH) communications. As illustrated, control manager 1110 can be coupled to interface process 1421 via a communications path 6130. In one or more embodiments, interface process 1421 can unconditionally accept data from CD 1510, or interface process 1421 can selectively accept data from CD 1510 and can determine what should be done with the data.

As illustrated, interface process 1421 can include network connections B-2c and B-2d. In one or more embodiments, each of network connections B-2c and B-2d can include a logical interface. In one example, network connection B-2c can be physically different from network connection B-2d. In a second example, network connections B-2c and B-2d can be logically different and share a same physical network interface. in another example, network connections B-2a, B-2b, B-2c, and B-2d can be logically different and share a same physical network interface.

In one or more embodiments, network connection B-2c can receive a SSH session via communications path 6110 that can attach to network connection B-2c. In one example, network connection B-2c can be the terminating point for this portion of the SSH session, and module moduel H-1 can perform an additional function such as a filtering function for commands that are directed to CS 1210. For instance, module H-1 can determine whether or not one or more of the commands are permitted. If a command is not permitted, module H-1 can respond to CD 1510, via network connection B-2c and communication path 6110, with information indicating that the command is not permitted. If a command is permitted, the command can be sent to module H-2, where module H-2 can determine whether or not the command is supported by CD 1210. For example, the command can include an enhanced command, an automation command, etc. that may not be directly supported by CD 1210.

If the command is an enhanced command or an automated command, H-2 will carry out any required function on CD 1210 via network connection B-2d and return a response to CD 1510 via network connection B-2c and communication path 6110. If the command is not an enhanced command or an automated command, the command can be passed to network connection B-2d which can send the command to CD 1210 via a communications path 6120. In one or more embodiments, communications path 6120 can include same or similar one or more structures and/or functionalities as described with reference to communications path 2120.

CD 1210 can process the command and can provide a response via communication path 6120 and B-2d. The response can be passed through modules H-2 and H-1 and can be provided to CD 1510 via network connection B-2c and communication path 6110. In one or more embodiments, module H-2 may or may not establish its own SSH session to CD 1210, or module H-2 can connect to CD 1210 via a different port and/or different protocol via network connection B-2d and communication path 6120 in carrying out one or more functions. In this fashion, CD 1510 can have SSH access to one or more services that appear as interface process 1421 while the one or more services are backed or partially backed by CD 1210.

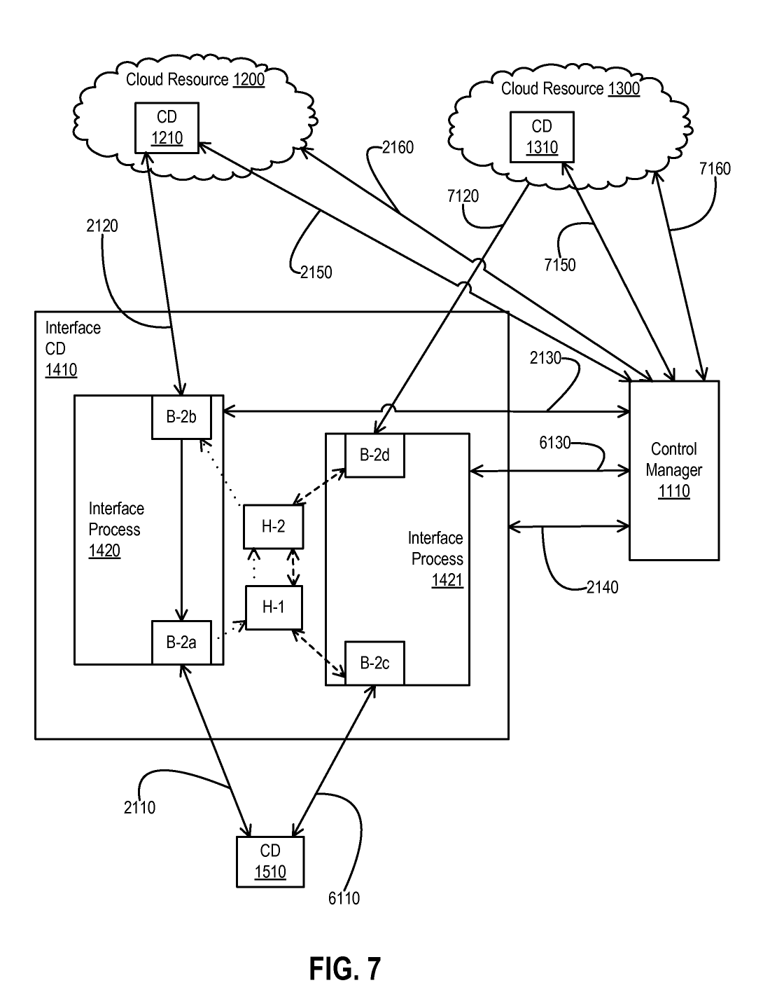

Turning now to FIG. 7, a diagram of an exemplary interface computing device, exemplary interface processes, and a split cloud resource configuration is illustrated, according to one or more embodiments. In one or more embodiments, interface CD 1410 can provide a composite and/or aggregate configuration of any number of cloud resources. For example, any number of cloud resources can include one or more of multiple cloud providers, multiple resource types, and multiple cloud types (IaaS, SaaS, PaaS, etc.), among others. In one or more embodiments, each cloud backing can be monitored and/or controlled by control manager 1110 which can provide coordination and/or can provide an aggregate derived single computing system or computing resource from the multiple clouds resources.

As illustrated, interface CD 1410 can provide a composite and/or aggregate configuration of at least two cloud resources (e.g., cloud resources 1200 and 1300). In this configuration, each cloud backing (e.g., CDs 1210 and 1310) can be monitored and/or controlled by control manager 1110 which can provide coordination and/or can provide an aggregate derived single computing system or computing resource from the multiple clouds resources from CDs 1210 and 1310.

For example, if one of CDs 1210 and 1310 becomes inaccessible (e.g., network outage, loss of power, etc.), the composite and/or aggregate provided by interface CD 1410 (e.g., via interface processes 1420 and 1410) can indicate an appropriate computing resource state via mirroring of one or more computing states derived from one or more computing states of cloud resources 1200 and 1300 (e.g., derived from one or more computing states of CDs 1210 and 1310). In one instance, control manager 1110 can derive the one or more computing states of cloud resources 1200 and 1300 from information associated with cloud resources 1200 and 1300 and communicated via communication paths 2160 and 7160, respectively. In one or more embodiments, communications path 7160 can be coupled to control manager 1110 and cloud resource 1300 and can include same or similar one or more structures and/or functionalities as described with reference to communications path 2160. In another instance, control manager 1110 can derive the one or more computing states of cloud resources 1200 and 1300 from information associated with CDs 1210 and 1310 communicated via communication paths 2150 and 7150, respectively. In one or more embodiments, communications path 7150 can be coupled to control manager 1110 and CD 1310 and can include same or similar one or more structures and/or functionalities as described with reference to communications path 2150.

In one or more embodiments, control manager 1110 can update and/or provide one or more computing states associated with cloud resources 1200 and 1300 to interface processes 1420 and 1421 via communication paths 2130 and 6130, respectively. In one or more embodiments, control manager 1110 can coordinate (e.g., mirror) the one or more computing states associated with cloud resources 1200 and 1300 with interface CD 1410 via communication path 2140. In one example, control manager 1110 determine one or more outdated computing states associated with cloud resources 1200 and 1300 from interface processes 1420 and 1421 via communication path 2140 and can update the one or more outdated computing states associated with cloud resources 1200 and 1300 with the one or more computing states associated with cloud resources 1200 and 1300 via communication path 2140.

In one or more embodiments, one or more of the systems, processes, and/or methods described herein can be abstracted away from an end resource consumer and one or more tools monitoring/leveraging an end resource (an end resource including interface processes 1420 and 1421 and interfaces presented to CD 1510). In one or more embodiments, communication paths 2110 and 6110 can share a same IP address and/or can operate utilizing ports. In one or more embodiments, communication paths 2110 and 6110 can respectively utilize two different IP addresses and/or utilize a same port. In one or more embodiments, communication paths 2110 and 6110 can respectively utilize two different networks.

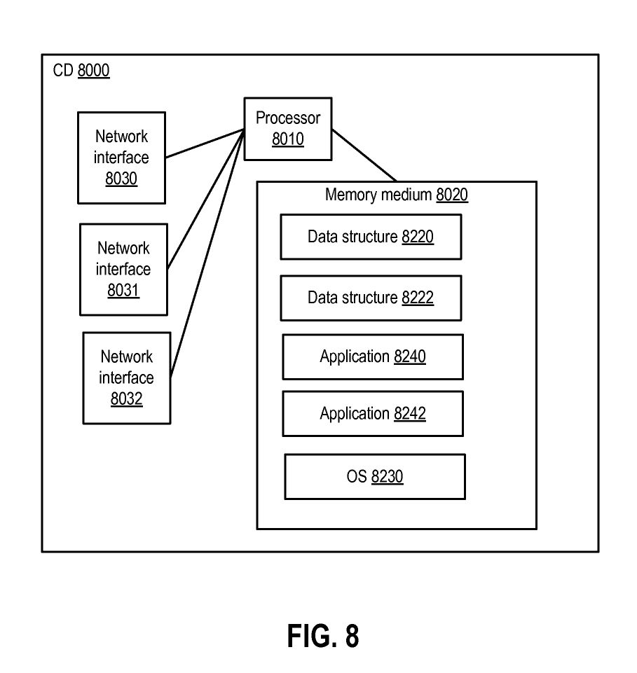

Turning now to FIG. 8, a block diagram of a computing device is illustrated, according to one or more embodiments. As shown, CD 8000 can include a memory medium 8020 coupled to a processor 8010, and CD 8000 can include one or more network interfaces 8030-8032. In one or more embodiments, memory medium 8210 can include one or more data structures 8220 and 8222, one or more applications 8240 and 8242, and/or an operating system (OS) 8230 that can include instructions executable by processor 8110 and/or data to implement one or more systems, processes, and/or methods described herein. In one or more embodiments, computer system 8000 may be any of various types of devices, including a server computer system, a networking appliance, a core network server, and/or a computing element of a cloud resource, among others. In one or more embodiments, processor 8110 can include one or more cores, and each core of processor 8110 can implement an instruction set architecture (ISA). In one or more embodiments, one or more of CDs 1210-1212, 1310-1312, interface CDs 1410 and 1610, CDs 1510-1512, and CDs 1710-1712 can include same or similar structures and/or functionality as described with reference to CD 8000. In one or more embodiments, one or more of control managers 1110 and 1120 can be implemented with a computing device that can include same or similar structures and/or functionality as described with reference to CD 8000.

In one or more embodiments, memory medium 8020 can include one or more memory media and/or one or more memory devices that are machine readable and/or computer readable. In one example, the one or more memory media and/or one or more memory devices can include one or more of RAM (random access memory), DRAM (dynamic RAM), SRAM (static RAM), EDO (extended data out) RAM, and DDR SDRAM (double data rate synchronous dynamic RAM), among others. In a second example, the one or more memory media and/or one or more memory devices can include one or more of NVRAM (non-volatile RAM), PROM (programmable read only memory), EPROM (erasable PROM), EEPROM, (electrically erasable PROM), and flash memory, among others. In a third example, the one or more memory media and/or one or more memory devices can include one or more of a CD-ROM (compact disc ROM), DVD-ROM (digital video disc ROM), a floppy disc, magnetic tape, a hard disc (including one or more magnetic data storage media), and a solid state drive, among others. In another example, the one or more memory media and/or one or more memory devices can include a distributed memory system. In one instance, the distributed memory system can include a storage area network (SAN). In a second instance, the distributed memory system can include a network attached storage (NAS). In another instance, the distributed memory system can include a network file system (NFS). In one or more embodiments, memory medium 8020 can include one or more combinations of a first memory medium and/or a first memory device that is/are included in CD 8000 in a combination with a second memory medium and/or a second memory device that is coupled to CD 8000 and is not included in CD 8000.

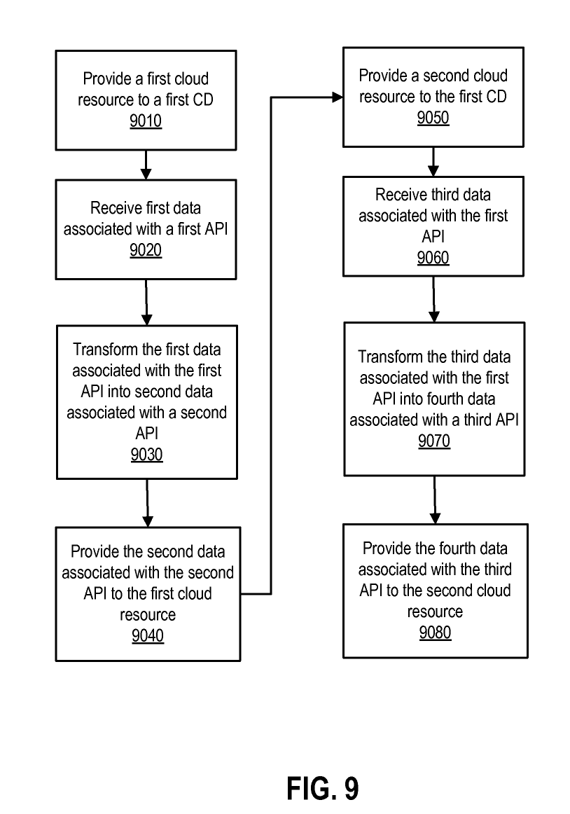

Turning now to FIG. 9, a method that provides one or more cloud resources to a computing device is illustrated, according to one or more embodiments. At 9010, a first cloud resource can be provided to a first CD. For example, interface CD 1410 can provide cloud resource 1200 to CD 1510. For instance, interface process 1420 can provide CD 1210 of cloud resource 1200 to CD 1510. At 9020, first data associated with a first API can be received. For example, interface process 1420 can implement the first API, and interface process 1420 can receive the first data associated with the first API.

At 9030, the first data associated with the first API can be transformed into second data associated with a second API, where the second API can be different from the first API. For example, interface process 1420 can transform the first data associated with the first API into second data associated with the second API. In one or more embodiments, the second API can be implemented and/or utilized by the first cloud resource. At 9040, the second data associated with the second API can be provided to the first cloud resource. For example, interface process 1420 can provide the second data associated with the second API to the first cloud resource.

At 9050, a second cloud resource can be provided to the first CD. For example, interface CD 1410 can provide cloud resource 1300 to CD 1510. For instance, interface process 1421 can provide CD 1310 of cloud resource 1300 to CD 1510. At 9060, third data associated with the first API can be received. For example, interface process 1421 can implement the first API, and interface process 1421 can receive the first data associated with the first API.

At 9070, the first data associated with the first API can be transformed into fourth data associated with a third API, where the third API can be different from the first API and the second API. For example, interface process 1421 can transform the third data associated with the first API into fourth data associated with the third API. In one or more embodiments, the third API can be implemented and/or utilized by the second cloud resource. At 9080, the fourth data associated with the third API can be provided to the second cloud resource. For example, interface process 1421 can provide the fourth data associated with the third API to the second cloud resource.

In one or more embodiments, providing CD 1210 to CD 1510 can include providing interface CD 1410 to CD 1510, where CD 1410 can represent a mirror of CD 1210. In one or more embodiments, providing CD 1310 to CD 1510 can include providing interface CD 1410 to CD 1510, where CD 1410 can represent a mirror of CD 1310. In one or more embodiments, providing the second cloud resource to CD 1510 can include providing interface CD 1410 to CD 1510, where interface CD 1410 can represent an aggregate of cloud resources 1200 and 1300. For example, interface CD 1410 can represent an aggregate of CDs 1210 and 1310.

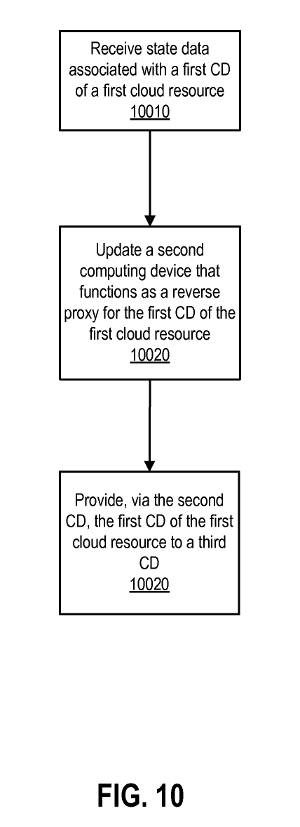

Turning now to FIG. 10, a method that provides a resource to a computing device is illustrated, according to one or more embodiments. At 10010, state data associated with a first computing device of a first cloud resource can be received. For example, control manager 1110 can receive state data associated with CD 1210 of cloud resource 1200. At 10020, a second computing device that functions as a reverse proxy for the first computing device of the first cloud resource can be updated. For example, interface CD 1410 can function as a reverse proxy for CD 1210 and can be updated with the state data associated with CD 1210. At 10030, the first computing device of the first cloud resource can be provided, via the second computing device, to a third computing device. For example, CD 1210 can be provided, via interface CD 1410, to CD 1510.

It is noted that, in one or more embodiments, one or more of the method elements described herein and/or one or more portions of an implementation of a method element can be performed in varying orders, can be repeated, can be performed concurrently with one or more of the other method elements and/or one or more portions of an implementation of a method element, or can be omitted. Additional and/or duplicated method elements can be performed as desired. For example, a process and/or method can perform one or more described method elements concurrently with duplicates of the one or more described method elements. For instance, multiple methods, processes, and/or threads can be implemented using same described method elements.

In one or more embodiments, concurrently can mean simultaneously. In one or more embodiments, concurrently can mean apparently simultaneously according to some metric. For example, two or more method elements and/or two or more portions of an implementation of a method element can be performed such that they appear to be simultaneous to a human. It is also noted that, in one or more embodiments, one or more of the system elements described herein may be omitted and additional system elements can be added as desired.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method, comprising:
providing a first cloud resource to a first computing device;
receiving first data associated with a first application programming interface (API);
transforming the first data associated with the first API into second data associated with a second API, wherein the second API is different from the first API; and
providing the second data associated with the second API to the first cloud resource.

2. The method of claim 1, wherein said providing the second data associated with the second API to the first cloud resource includes providing the second data associated with the second API to at least a second computing device included in the cloud resource.

3. The method of claim 2, wherein said providing the first cloud resource to the first computing device includes providing a third computing device to the first computing device that represents a mirror of the second computing device included in the first cloud resource.

4. The method of claim 1, further comprising:
providing a second cloud resource to the first computing device;
receiving third data associated with the first API;
transforming the third data associated with the first API into fourth data associated with a third API, wherein the third API is different from the first API and is different from the second API; and
providing the fourth data associated with the third API to the second cloud resource.

5. The method of claim 4, wherein said providing the fourth data associated with the third API to the second cloud resource includes providing the fourth data associated with the third API to at least a third computing device included in the second cloud resource.

6. The method of claim 5, wherein said providing the second cloud resource to the first computing device includes providing the third computing device to the first computing device that represents an aggregate of the second computing device included in the first cloud resource and the third computing device included in the second cloud resource.

7. A method, comprising:
receiving state data associated with a first computing device of a first cloud resource;
updating a second computing device that functions as a reverse proxy for the first computing device of the first cloud resource; and
providing, via the second computing device, the first computing device of the first cloud resource to a third computing device.

8. The method of claim 7,
wherein the reverse proxy receives first data associated with a first application programming interface (API) from the first computing device, transforms the first data associated with the first API into second data associated with a second API, and provides the second data associated with the second API to the first cloud resource; and
wherein the second API is different from the first API.

9. A system, comprising:
a reverse proxy that provides a first cloud resource to a first computing device, receives first data associated with a first application programming interface (API) from the first computing device, transforms the first data associated with the first API into second data associated with a second API, and provides the second data associated with the second API to the first cloud resource, wherein the second API is different from the first API.

10. The system of claim 9, further comprising:
the first computing device.

11. The system of claim 9, wherein the reverse proxy provides the first cloud resource to the first computing device via a private network.

12. The system of claim 9, wherein the reverse proxy provides the first cloud resource to the first computing device via a secure communication path.

13. The system of claim 9, wherein when the reverse proxy provides the first cloud resource to the first computing device, the reverse proxy provides the first cloud resource as a local resource to the first computing device.

14. The system of claim 9, further comprising:
a control manager that receives state data associated with the first cloud resource and updates the reverse proxy with the state data associated with the first cloud resource.
